(19) United States
(12) Patent Application Publication
(10) Pub. No.: US 2020/0124021 A1
(43) Pub. Date: Apr. 23, 2020

(54) TURBINE ASSEMBLY FOR INSTALLATION INSIDE A PIPE

(71) Applicant: Clint V. Reil, Miles City, MT (US)

(72) Inventor: Clint V. Reil, Miles City, MT (US)

(21) Appl. No.: 16/163,203

(22) Filed: Oct. 17, 2018

(51) Int. Cl. F03B 17/06; F03B 3/06; F03B 11/06; E03B 7/07; H02K 7/18

(52) U.S. Cl. CPC F03B 17/061; F03B 3/06; H02K 7/1823; F03B 11/063; E03B 7/075; F03B 17/062

(57) ABSTRACT

A turbine assembly for installation inside a pipe section in which a fluid flows. The turbine assembly includes a shaft and one or more blades. The shaft is couplable to a generator and has a portion positionable inside the pipe section. The blade(s) is/are attached to the portion of the shaft. The blade(s) is/are pushed upon by the fluid as the fluid flows within the pipe section causing the one or more blades to rotate the shaft. The shaft is operable to cause the generator to generate electricity as the shaft is rotated by the blade(s). A pressure of the fluid is reduced as the fluid pushes on the blade(s) and causes the blade(s) to rotate the shaft.

### BACKGROUND OF THE INVENTION

### Field of the Invention

The present invention is directed generally to turbine assemblies.

### Description of the Related Art

In a public water system, pipes often carry potable water from a higher elevation to a lower elevation (e.g., to be used as drinking water). Water pressure increases as the water travels downwardly. Prior art water pipes are typically fitted with one or more Pressure Reducing Valve (“PRV”) configured to reduce the water pressure to a safe level. While PRVs are effective at reducing the water pressure, PRVs are expensive and merely dissipate the excess pressure.

### BRIEF DESCRIPTION OF THE SEVERAL VIEWS OF THE DRAWING(S)

FIG. 1 is a block diagram illustrating a fluid transfer system including a turbine assembly that is installed in a pipe section of the fluid transfer system.

FIG. 2 is a top view of an exemplary implementation of a portion of the fluid transfer system of FIG. 1.

FIG. 3 is a cross-sectional view of the portion of the fluid transfer system illustrated in FIG. 2.

FIG. 4 is an enlarged cross-sectional view of a portion of the fluid transfer system taken through a line 4-4 illustrated in FIG. 2.

FIG. 5 is an enlarged exploded perspective view of a first end cap and a first bearing assembly.

FIG. 6 is an enlarged exploded perspective view of a second end cap and a second bearing assembly.

FIG. 7 is an enlarged side view of a shaft and blades of the turbine assembly.

FIG. 8 is an enlarged perspective view of the shaft being inserted into an opening of a generator.

FIG. 9 is a perspective view of a first alternate embodiment in which the turbine assembly includes a vertical axis turbine.

FIG. 10 is a perspective view of a second alternate embodiment in which the turbine assembly includes a Kaplan turbine.

FIG. 11 is an enlarged cross-sectional view of a third alternate embodiment of the turbine assembly installed in the fluid transfer system of FIG. 2.

Like reference numerals have been used in the figures to identify like components.

### DETAILED DESCRIPTION OF THE INVENTION

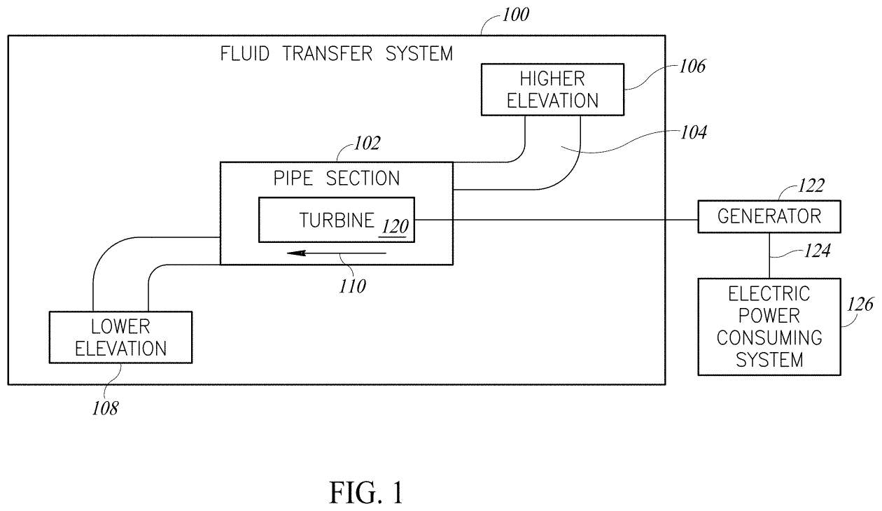

FIG. 1 is a block diagram of a fluid transfer system 100 having a pipe section 102 that receives a fluid 104 from a higher elevation 106 and conducts the fluid 104 in a flow direction (identified by an arrow 110) to a lower elevation 108. Thus, a pressure of the fluid 104 increases inside the pipe section 102 as the fluid 104 flows therethrough in the flow direction (identified by the arrow 110). By way of a non-limiting example, the fluid transfer system 100 may be a public (e.g., municipal) water system that delivers drinking water to residents. In such embodiments, the pipe section 102 may be implemented as a large water pipe (referred to as a mainline) or a smaller water pipe that branches from a mainline.

The fluid transfer system 100 includes a turbine assembly 120 installed in the pipe section 102. The turbine assembly 120 is configured to use the increased fluid pressure in the pipe section 102 as a source of energy. Thus, the turbine assembly 120 obtains energy from the flowing fluid 104 and converts that energy to mechanical motion. The turbine assembly 120 is electrically coupled or mechanically connected to a power generation device or generator 122. The generator 122 is configured to convert the mechanical motion of the turbine assembly 120 into electric power and conduct the electric power (e.g., via one or more electrical leads or lines 124) to an electric power consuming system 126. By way of a non-limiting example, the turbine assembly 120 may be configured to drive the generator 122 to achieve at least a minimum output power (e.g., about 2 kilowatts (“kW”)).

The electric power consuming system 126 may be operated by an operator of the fluid transfer system 100 or a third party. For example, the electric power consuming system 126 may be a power system or grid operated by a public utility. In such embodiments, electricity generated by the generator 122 may be sold to the public utility to offset the price of installation of the turbine assembly 120 and/or the generator 122. By way of another non-limiting example, the electricity generated may be sold to the public utility to provide a financial return on an initial investment associated with installing the turbine assembly 120 and/or the generator 122.

By way of yet another non-limiting example, the electric power consuming system 126 may an off-the-grid home near a stream or river. In such embodiments, the fluid transfer system 100 may be implemented as the stream or river. Together, the turbine assembly 120 and the generator 122 may provide environmentally friendly electricity to the home.

In addition to generating electricity, the turbine assembly 120 reduces the pressure of the fluid 104 inside the pipe section 102. Thus, the turbine assembly 120 may be installed in the pipe section 102 instead of one or more PRVs. The turbine assembly 120 may be configured to reduce the fluid pressure inside the pipe section 102 to below a maximum threshold value (e.g., about 80 pounds per square inch (“psi”)). Additionally, the turbine assembly 120 may be configured not to lower the fluid pressure inside the pipe section 102 below a minimum threshold value (e.g., less than or equal to 5 pounds per square inch).

By way of a non-limiting example, the pipe section 102 may have a diameter of about 36 inches to 48 inches configured to convey about 3000 gallons per minute (“gpm”) of fluid (e.g., water). However, the turbine assembly 120 may be scaled and implemented in a wide variety of pipe sections that have different flow rates and pipe diameters. For example, the turbine assembly 120 may be scaled for installation in pipe sections having a diameter ranging from 6 inches to 48 inches.

In embodiments in which the fluid 104 is drinking water, the fluid 104 may remain potable at the exit of the pipe section 102. For example, materials used to construct and install the turbine assembly 120 in the pipe section 102 (e.g., sealants, barrier materials, and coatings) may be certified as complying with NSF/ANSI Standard 61 for Drinking Water System Components. “NSF” was originally initials for National Sanitation Foundation and “ANSI” are initials for American National Standards Institute. Additionally, the materials used to construct and install the turbine assembly 120 in the pipe section 102 may have a contamination level below a Maximum Contaminant Level (“MCL”) set by the U.S. Environmental Protection Agency (“EPA”) in the Safe Drinking Water Act for community drinking water.

The turbine assembly 120 may be configured not to significantly disrupt the flow of the fluid 104. The turbine assembly 120 may be configured for continuously long-term usage (e.g., to operate for at least 15 years). The turbine assembly 120 may have an operating frequency that is below 0.2 times the natural frequency or above 1.4 times the natural frequency to minimize vibrational force and displacement transmissibility.

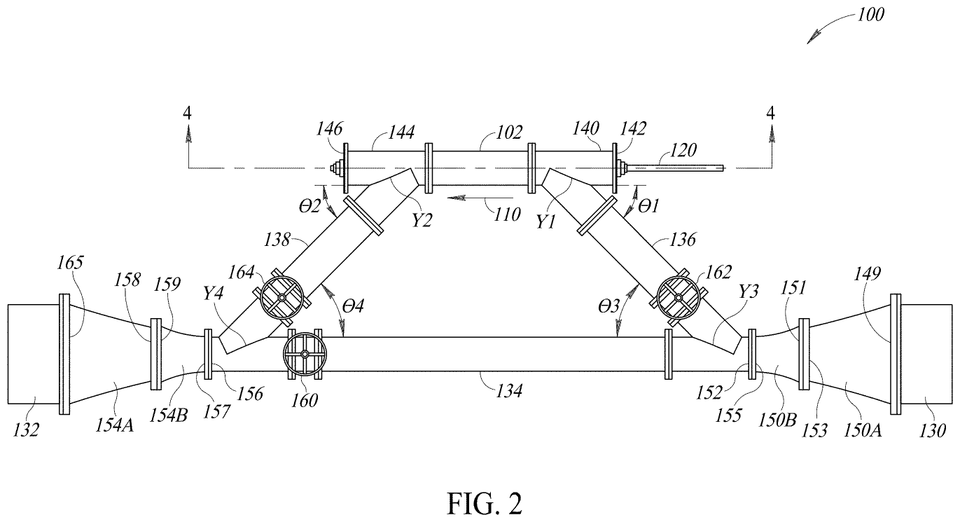

FIG. 2 illustrates an exemplary implementation of a portion of the fluid transfer system 100. In the example illustrated, the fluid transfer system 100 is implemented as a public water system and the fluid 104 (see FIG. 1) is implemented as drinking water. In this example, the fluid transfer system 100 includes a first mainline section 130 that receives the fluid 104 (see FIG. 1) from the higher elevation 106 (see FIG. 1) and a second mainline section 132 that delivers the fluid 104 to the lower elevation 108 (see FIG. 1). Each of the first and second mainline sections 130 and 132 has a first diameter (e.g., about 36 inches).

The pipe section 102 is connected to the first and second mainline sections 130 and 132 by first and second branch pipe sections 136 and 138, respectively. The first branch pipe section 136 is connected to the pipe section 102 at a first angle θ1 (e.g., about 45 degrees). A first end portion 140 of the pipe section 102 extends outwardly beyond the first branch pipe section 136 and is terminated by a first end cap 142. Thus, together, the pipe section 102 and the first branch pipe section 136 may define a first wye-shaped connection “Y1.” The second branch pipe section 138 is connected to the pipe section 102 at a second angle 82 (e.g., about 45 degrees). A second end portion 144 of the pipe section 102 extends outwardly beyond the second branch pipe section 138 and is terminated by a second end cap 146. Thus, together, the pipe section 102 and the second branch pipe section 138 may define a second wye-shaped connection “Y2.”

The first branch pipe section 136 is connected to the first mainline section 130 at a third angle θ3 (e.g., about 45 degrees). In the embodiment illustrated, one or more reducers 150A and 150B connect the first mainline section 130 to a first end 152 of an optional bypass pipe section 134. The first branch pipe section 136 is connected to the bypass pipe section 134 near its first end 152. Thus, together, the first branch pipe section 136 and the bypass pipe section 134 may define a third wye-shaped connection “Y3.” At the third wye-shaped connection “Y3,” the fluid 104 (see FIG. 1) may flow from the first mainline section 130 into the first branch pipe section 136 and/or the bypass pipe section 134.

The bypass pipe section 134 connects the first and second mainline sections 130 and 132 together and bypasses the pipe section 102. The bypass pipe section 134 may have a second diameter (e.g., about 12 inches) that is smaller than the first diameter (e.g., about 36 inches). A larger diameter end 149 of the reducer 150A may be connected directly to the first mainline section 130. The reducer 150A may decrease the first diameter (e.g., about 36 inches) of the first mainline section 130 to a modified first diameter (e.g., about 20 inches). A larger diameter end 151 of the reducer 150B may be connected to a smaller diameter end 153 of the reducer 150A. The reducer 150B may decrease the modified first diameter (e.g., about 20 inches) to the second diameter (e.g., about 12 inches). Thus, a smaller diameter end 155 of the reducer 150B may be connected directly to the first end 152 of the bypass pipe section 134.

The reducers 150A and 150B increase a flow rate or velocity of the fluid 104 entering the first end 152 of the bypass pipe section 134. In the embodiment illustrated, the flow velocity of the fluid 104 entering the first end 152 of may be about 8.5 feet per second, which is below a standardized maximum flow velocity of 10 feet per second.

The second branch pipe section 138 is connected to the second mainline section 132 at a fourth angle θ4 (e.g., about 45 degrees). In the embodiment illustrated, one or more reducers 154A and 154B connect the second mainline section 132 to a second end 156 of the bypass pipe section 134. The second branch pipe section 138 is connected to the bypass pipe section 134 near its second end 156. Thus, together, the second branch pipe section 138 and the bypass pipe section 134 may define a fourth wye-shaped connection “Y4.”

A smaller diameter end 157 of the reducer 154B may be connected directly to the second end 156 of the bypass pipe section 134. By way of a non-limiting example, the reducer 154B increases the second diameter (e.g., about 12 inches) to the modified first diameter (e.g., about 20 inches). A smaller diameter end 158 of the reducer 154A may be connected to a larger diameter end 159 of the reducer 154B. The reducer 154A may increase the modified first diameter (e.g., about 20 inches) to the first diameter (e.g., from about 36 inches) of the second mainline section 132. Thus, a larger diameter end 165 of the reducer 154A may be connected directly to the second mainline section 132. The reducers 154A and 154B reduce the flow velocity of the fluid 104 exiting the bypass pipe section 134.

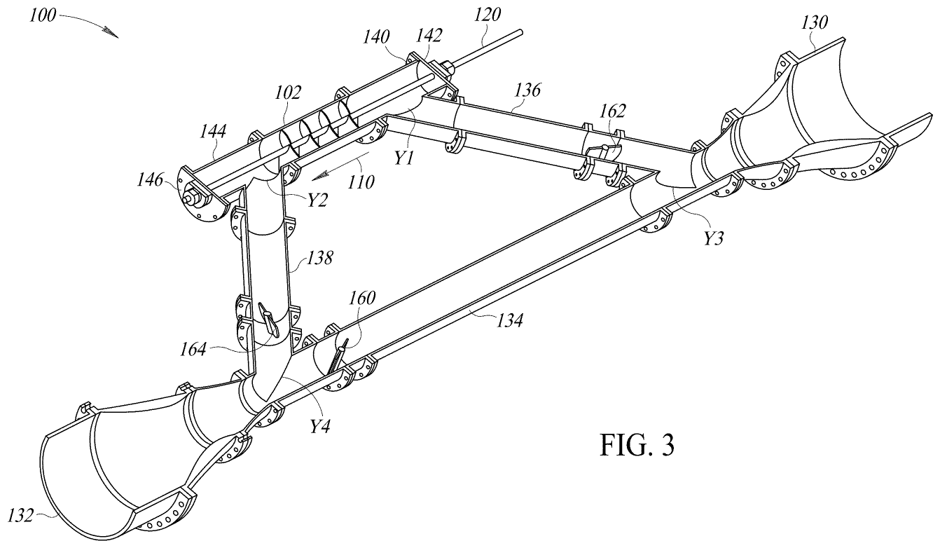

Referring to FIGS. 2 and 3, an optional valve 160 may be positioned in the bypass pipe section 134. Optionally, a first valve 162 may be positioned in the first branch pipe section 136 and a second valve 164 may be positioned in the second branch pipe section 138. By way of a non-limiting example, the valves 160-164 may each be implemented as a butterfly valve. The valves 160-164 may be used to control flow velocities through the pipe sections 134-138, respectively. The valve 160 may be closed to prevent the fluid 104 (see FIG. 1) from flowing through the bypass pipe section 134. The valves 162 and 164 may each be closed to stop the fluid 104 (see FIG. 1) from flowing into the first and second branch pipe sections 136 and 138, respectively. During operation, the valve 160 may be closed and the valves 162 and 164 opened, which forces all of the fluid 104 (see FIG. 1) to flow through the pipe section 102. On the other hand, the valves 162 and 164 may each be closed and the valve 160 opened to force all of the fluid 104 (see FIG. 1) to flow through the bypass pipe section 134 (e.g., if the turbine assembly 120 requires maintenance). Alternatively, the valves 160-164 may each be opened to allow the fluid 104 (see FIG. 1) to flow through both the pipe section 102 and the bypass pipe section 134.

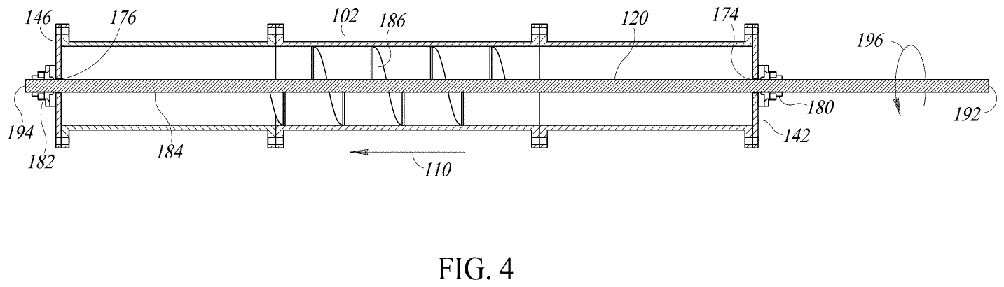

As shown in FIG. 3, the first end portion 140 of the pipe section 102 extends outwardly from the first wye-shaped connection “Y1” in a direction opposite the flow direction (identified by the arrow 110). The second end portion 144 of the pipe section 102 extends outwardly from the second wye-shaped connection “Y2” in the flow direction (identified by the arrow 110). The first and second end portions 140 and 144 are closed by the end caps 142 and 146, respectively. Referring to FIG. 4, the end caps 142 and 146 include through-holes 174 and 176, respectively. The through-holes 174 and 176 are positioned at or near the centers of the end caps 142 and 146, respectively.

Referring to FIG. 4, the turbine assembly 120 may be implemented as an Archimedes screw turbine (referred to hereafter as a screw turbine), an upright or vertical axis turbine, a Kaplan turbine, and the like. In the embodiment illustrated in FIG. 4, the turbine assembly 120 has been implemented as a screw turbine that includes a first bearing assembly 180, a second bearing assembly 182, a shaft 184, and one or more blades 186.

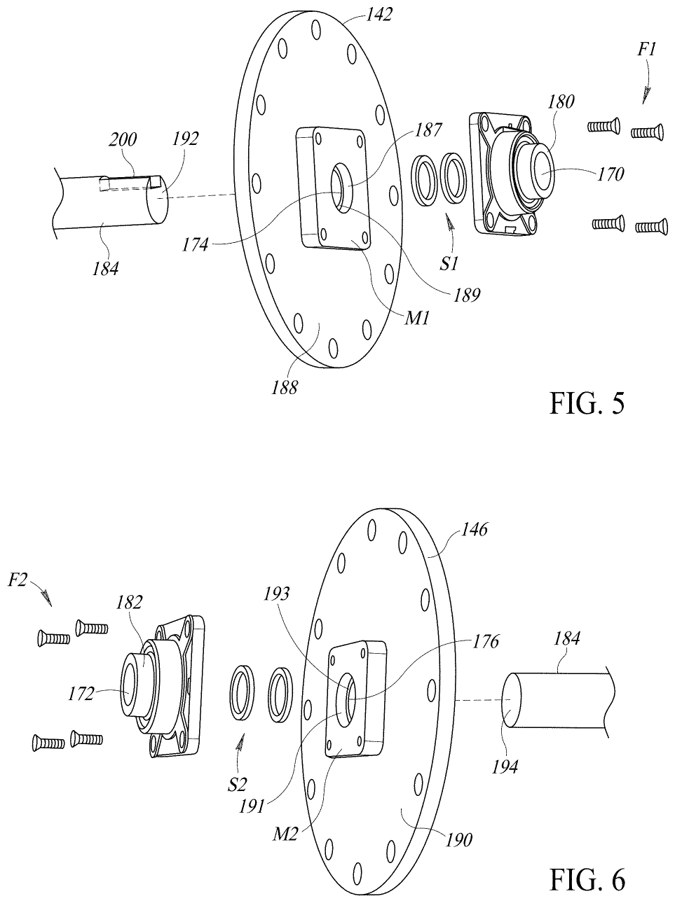

Referring to FIG. 5, the first bearing assembly 180 is configured to be received inside or positioned adjacent to the through-hole 174 of the first end cap 142. In the embodiment illustrated, the first end cap 142 has an outwardly facing side 188. A first housing or mount “M1” is attached to the outwardly facing side 188 and forms a fluid-tight seal therewith. The first mount “M1” includes a through-hole 187 that is aligned with the through-hole 174 and configured to allow a first end portion 192 of the shaft 184 to pass therethrough. The through-hole 187 may include a lip 189. One or more seals “S1” may be positioned inside the through-hole 187 and abut the lip 189. The first bearing assembly 180 may be attached to the first end cap 142 or the first mount “M1” by one or more fasteners “F1.” The first bearing assembly 180 has a through-channel 170 configured to be aligned with the through-holes 174 and 187 and allow the first end portion 192 of the shaft 184 to pass therethrough. The shaft 184 is rotatable inside the through-channel 170 with respect to the end cap 142. The seal(s) “51” may create a fluid-tight seal between the first mount “M1” and the first bearing assembly 180. By way of a non-limiting example, each of the seal(s) “S1” may be implemented as an O-ring, a radial double lip seal, and the like. By way of another non-limiting example, each of the fastener(s) “F1” may be implemented as a bolt.

Referring to FIG. 4, the first bearing assembly 180 may be configured to prevent radial movement of the shaft 184 and support most the radial load. The first bearing assembly 180 may be implemented as a radial bearing assembly configured to prevent the shaft 184 from moving radially within the pipe section 102. The first bearing assembly 180 may be configured to operate at about 400 revolutions per minute (“RPM”). By way of a non-limiting example, the first bearing assembly 180 may be implemented as a SKF FY 2 TF ball bearing assembly sold by Motion Industries.

The second bearing assembly 182 is configured to be received inside or positioned adjacent to the through-hole 176 of the second end cap 146. Referring to FIG. 6, in the embodiment illustrated, the second end cap 146 has an outwardly facing side 190. A second housing or mount “M2” is attached to the outwardly facing side 190 and forms a fluid-tight seal therewith. The second mount “M2” includes a through-hole 191 that is aligned with the through-hole 176 and configured to allow a second end portion 194 of the shaft 184 to pass therethrough. The through-hole 191 may include a lip 193. One or more seals “S2” may be positioned inside the through-hole 191 and abut the lip 193. The second bearing assembly 182 may be attached to the second end cap 146 or the second mount “M2” by one or more fasteners “F2.” The second bearing assembly 182 has a through-channel 172 configured to be aligned with the through-holes 176 and 191 and allow the second end portion 194 of the shaft 184 to pass therethrough. The shaft 184 is rotatable inside the through-channel 172 with respect to the end cap 146. The seal(s) “S2” may create a fluid-tight seal between the second mount “M2” and the second bearing assembly 182. By way of a non-limiting example, each of the seal(s) “S2” may be implemented as an O-ring, a radial double lip seal, and the like. By way of another non-limiting example, each of the fastener(s) “F2” may be implemented as a bolt.

Referring to FIG. 4, the second bearing assembly 182 may prevent the shaft 184 from moving axially and resist thrust forces caused by the fluid 104 (see FIG. 1) pushing on the blade(s) 186 as the fluid 104 flows through the pipe section 102. The second bearing assembly 182 may be implemented as a thrust bearing assembly configured to prevent the shaft 184 from moving linearly (e.g., in the flow direction identified by the arrow 110) within the pipe section 102. The second bearing assembly 182 may be configured to operate at about 400 RPM. By way of a non-limiting example, the second bearing assembly 182 may be implemented as a SKF FYE 2 N cylindrical roller bearing assembly sold by Motion Industries.

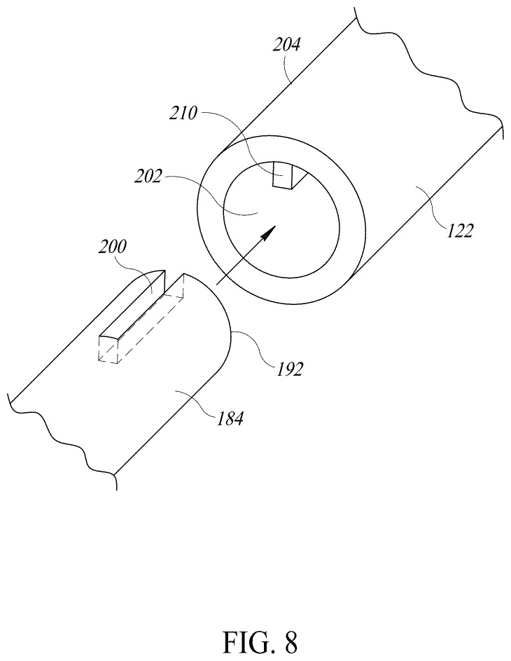

The shaft 184 may be generally linear and arranged substantially parallel with the flow direction (identified by the arrow 110). Thus, the shaft 184 may extend along the flow direction (identified by the arrow 110). The first end portion 192 is opposite the second end portion 194 of the shaft 184. The first end portion 192 extends outwardly from the pipe section 102 through the through-hole 174 formed in the first end cap 142, the through-hole 187 formed in the first mount “M1” (see FIG. 5), and the through-channel 170 (see FIG. 5) of the first bearing assembly 180. The first end portion 192 is rotatable in a rotation direction (identified by a curved arrow 196) within the first bearing assembly 180. The first end portion 192 extends outwardly from the pipe section 102 beyond the first end cap 142 far enough to be connected to the generator 122 (see FIGS. 1 and 8).

The second end portion 194 extends outwardly from the pipe section 102 through the through-hole 176, the through-hole 191 formed in the second mount “M2” (see FIG. 6), and through-channel 172 (see FIG. 6) of the second bearing assembly 182. The second end portion 194 is rotatable in the rotation direction (identified by the curved arrow 196) within the second bearing assembly 182. Thus, the shaft 184 extends through the first and second bearing assembles 180 and 182 and is rotatable therein. The second end portion 194 may terminate close to the second bearing assembly 182.

Referring to FIG. 8, by way of a non-limiting example, the shaft 184 may be implemented as a cylindrically shaped bar or rod having an outer diameter (e.g., about 2 inches). The first end portion 192 of the shaft 184 is configured to be connected to the generator 122. Optionally, the first end portion 192 may have a keyway or keyseat 200 formed therein. By way of a non-limiting example, the keyseat 200 may be implemented as a grove. The generator 122 may have an opening 202 with an inner diameter (e.g., of about 2 inches) configured to receive the outer diameter of the first end portion 192. The opening 202 may be formed in a rotatable component 204 that has a key 210 configured to engage the keyseat 200. When the key 210 is engaged with the keyseat 200, the rotatable component 204 is rotated by the shaft 184 as the shaft 184 rotates. By way of a non-limiting example, the key 210 may be 0.5 inches square and constructed of steel.

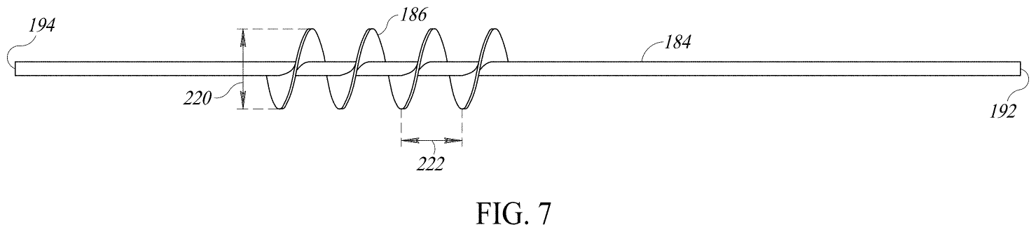

Referring to FIG. 4, the blade(s) 186 are configured to cause the shaft 184 to rotate when the fluid 104 (see FIG. 1) flows through the pipe section 102. In other words, the shaft 184 rotates with the blade(s) 186 as a unit. Referring to FIG. 7, in the embodiment illustrated, the blade(s) 186 wrap helically around the shaft 184 and extend outwardly from the shaft 184. In such embodiments, the blade(s) 186 may have an outer diameter 220 (e.g., about 11.5 inches), a thickness (e.g., about 0.25 inches), and a pitch 222 (e.g., about 9 inches). All of the blade(s) 186 may have substantially identical outer diameters that define a sweep profile that is parallel with the shaft 184. Alternatively, one or more of the blade(s) 186 may have different outer diameters that define a sweep profile that is not parallel with the shaft 184. In the embodiment illustrated, the blade(s) 186 make four complete revolutions around the shaft 184. However, this is not a requirement. Each complete revolution around the shaft 184 may be constructed as a separate blade.

Referring to FIG. 4, an amount of pressure decrease caused by the turbine assembly 120 may be adjusted by changing the blade(s) 186. For example, a length of the blade(s) 186 along the shaft 184 and/or the number of revolutions the blade(s) 186 make around the shaft 184 may be adjusted.

By way of a non-limiting example, both the shaft 184 and the blade(s) 186 may each be constructed from stainless steel. The blade(s) 186 may be constructed using three-dimensional printing.

Referring to FIG. 1, in the embodiment illustrated, the generator 122 is positioned outside the pipe section 102 and is connected directly to the shaft 184, which extends outwardly from the pipe section 102. Alternatively, the shaft 184 may be positioned entirely inside the pipe section 102. In such embodiments, the shaft 184 may include magnets (not shown) that rotate as the shaft 184 rotates. The magnets (not shown) may be electrically coupled to a coil (not shown) of the generator 122, which is positioned outside the pipe section 102. As the magnets (not shown) are rotated by the shaft 184, the magnets (not shown) may induce an electric current in the coil (not shown). By way of another non-limiting example, the generator 122 may be positioned within the pipe section 102. In such implementations, only the line(s) 124 may exit from the pipe section 102 (e.g., via one or more openings formed in the first end cap 142).

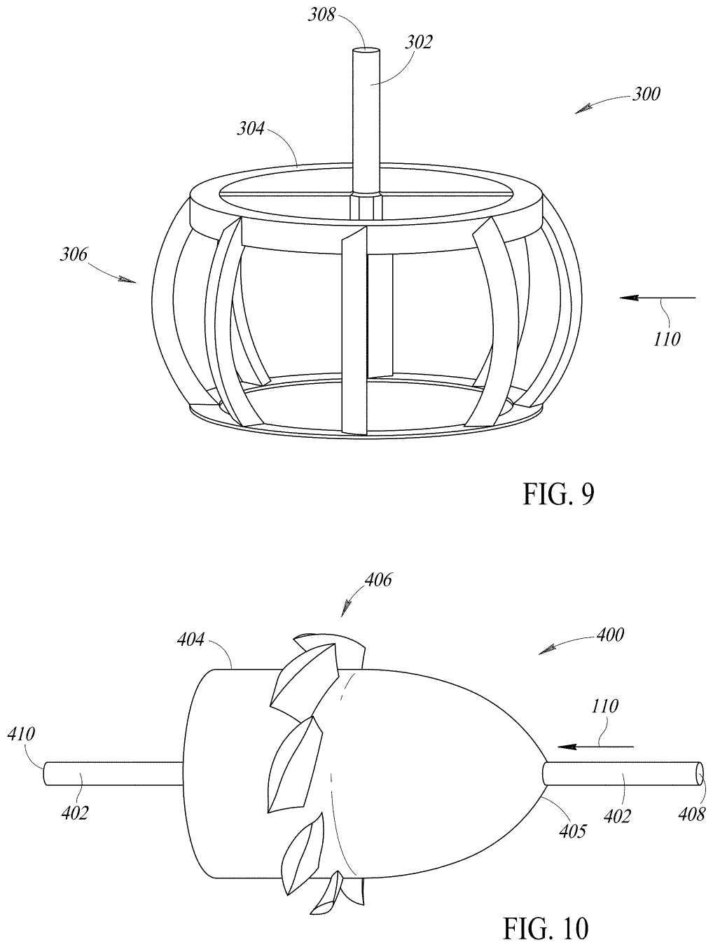

FIG. 9 illustrates an alternate embodiment of the turbine assembly 120 (see FIGS. 1-4) that includes a vertical axis turbine 300 instead of the shaft 184 (see FIGS. 4-8) and the blade(s) 186 (see FIGS. 4 and 7). In this embodiment, the first and second end caps 142 and 146 (see FIG. 4) may omit the through-holes 174 and 176 (see FIG. 4), respectively, and the turbine assembly 120 (see FIGS. 1-4) may omit the first and second bearing assemblies 180 and 182 (see FIG. 4). The vertical axis turbine 300 includes a shaft 302 that is substantially orthogonal to the flow direction (identified by the arrow 110) of the fluid 104 (see FIG. 1). Thus, a through-hole (not shown) may be formed in the pipe section 102 (see FIGS. 1-4) through which the shaft 302 may exit the pipe section 102. A bearing assembly (not shown) like the first bearing assembly 180 (see FIGS. 4 and 5) may be positioned at or near the through-hole (not shown) and the shaft 302 may rotate in the bearing assembly.

The shaft 302 is connected to a rotatable member 304 that includes a plurality of blades 306. The rotatable member 304 is configured to be rotated by the fluid 104 (see FIG. 1) as the fluid 104 pushes on the blades 306. The shaft 302 rotates with the rotatable member 304 as a unit. The generator 122 (see FIGS. 1 and 8) may be connected to an end portion 308 of the shaft 302 in the same manner the generator 122 may be connected to the first end portion 192 (see FIGS. 4, 5, 7, and 8) of the shaft 184 (see FIGS. 4-8). Thus, the vertical axis turbine 300 may be used to generate electricity and reduce the pressure of the fluid 104 (see FIG. 1).

FIG. 10 illustrates an alternate embodiment of the turbine assembly 120 (see FIGS. 1-4) that includes a Kaplan turbine 400 instead of the shaft 184 (see FIGS. 4-8) and the blade(s) 186 (see FIGS. 4 and 7). In this embodiment, the Kaplan turbine 400 includes a shaft 402 that is substantially parallel to the flow direction (identified by the arrow 110) of the fluid 104 (see FIG. 1).

The shaft 402 is connected to a rotatable member 404 that includes a plurality of blades 406. The rotatable member 404 is configured to be rotated by the fluid 104 (see FIG. 1) as the fluid 104 pushes against the blades 406. The rotatable member 404 may be generally bullet shaped with a tapered end portion 405. The shaft 402 rotates with the rotatable member 404 as a unit. The shaft 402 has a first end portion 408 opposite a second end portion 410. The tapered end portion 405 is nearer the first end portion 408 and faces in a direction opposite the flow direction (identified by the arrow 110).

At least one of the end portions 408 and 410 of the shaft 402 may extend outwardly from the pipe section 102 (see FIGS. 1-4). For example, the first end portion 408 may extend outwardly from the pipe section 102 (see FIGS. 1-4) through the through-hole 174 (FIGS. 4 and 6), the through-hole 187 (see FIG. 5) formed in the first mount “M1” (see FIG. 5), and through-channel 170 (see FIG. 5) of the first bearing assembly 180. The generator 122 (see FIGS. 1 and 8) may be connected to the first end portion 408 of the shaft 402 in the same manner the generator 122 may be connected to the first end portion 192 (see FIGS. 4, 5, 7, and 8) of the shaft 184 (see FIGS. 4-8). In this manner, the Kaplan turbine 400 may be used to generate electricity and reduce the pressure of the fluid 104 (see FIG. 1).

By way of another non-limiting example, the second end portion 410 may extend outwardly from the pipe section 102 (see FIGS. 1-4) through the through-hole 176 (FIGS. 4 and 6), the through-hole 191 (see FIG. 6) formed in the second mount “M2” (see FIG. 6), and through-channel 172 (see FIG. 6) of the second bearing assembly 182. The generator 122 (see FIGS. 1 and 8) may be connected to the second end portion 410 of the shaft 402 in the same manner the generator 122 may be connected to the first end portion 192 (see FIGS. 4, 5, 7, and 8) of the shaft 184 (see FIGS. 4-8). In this manner, the Kaplan turbine 400 may be used to generate electricity and reduce the pressure of the fluid 104 (see FIG. 1).

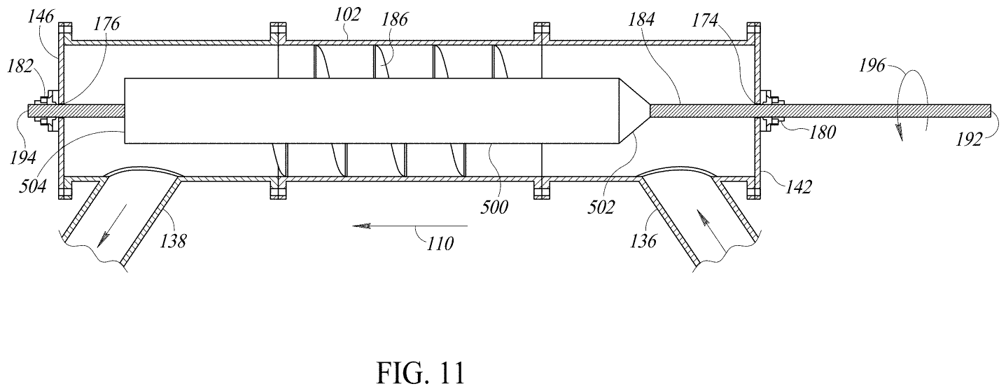

FIG. 11 illustrates an alternate embodiment of the turbine assembly 120 (see FIGS. 1-4) that includes a body portion 500 attached to the shaft 184. The blade(s) 186 are mounted on the body portion 500 and rotate the body portion 500 and the shaft 184 together as a unit. Thus, the body portion 500 attaches the blade(s) 186 to the shaft 184. The body portion 500 may have a tapered first end portion 502 opposite a second end portion 504. The tapered first end portion 502 is nearer the first end portion 408 of the shaft 184 and faces in a direction opposite the flow direction (identified by the arrow 110).

In this embodiment, the pipe section 102 has a larger lateral cross-section (e.g., a diameter) than the pipe section 102 illustrated in FIGS. 1-4. By way of non-limiting examples, the pipe section 102 may have a diameter of about 6 inches in FIGS. 1-4 and a diameter of about 10 inches in FIG. 11.

The body portion 500 has a larger cross-section (e.g., a diameter) than the shaft 184. By way of non-limiting examples, the body portion 500 may have a diameter of about 6 inches and the shaft 184 may have a diameter of about 2 inches.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A turbine assembly for installation inside a pipe section, a fluid flowing within the pipe section, the turbine assembly comprising:
a shaft having a portion positionable inside the pipe section, the shaft being couplable to a generator; and
one or more blades attached to the portion of the shaft, the one or more blades being pushed upon by the fluid as the fluid flows within the pipe section causing the one or more blades to rotate the shaft, the shaft being operable to cause the generator to generate electricity as the shaft is rotated by the one or more blades, a pressure of the fluid being reduced as the fluid pushes on the one or more blades and causes the one or more blades to rotate the shaft.

2. The turbine assembly of claim 1 for use with the fluid flowing in a flow direction, wherein the portion of the shaft extends along the flow direction.

3. The turbine assembly of claim 2 for use with the pipe section comprising a first end cap configured to terminate a first end portion of the pipe section and a second end cap configured to terminate a second end portion of the pipe section, the first end portion being opposite the second end portion, the first and second end caps comprising first and second through-holes, respectively, the turbine assembly further comprising:
a first bearing assembly configured to be connected to the first end cap at or near the first through-hole, a first end of the shaft being configured to extend through the first through-hole and the first bearing assembly, the first end of the shaft being couplable to the generator, the shaft being rotatable in the first bearing assembly with respect to the first end cap; and
a second bearing assembly configured to be connected to the second end cap at or near the second through-hole, a second end of the shaft being configured to extend through the second through-hole and the second bearing assembly, the shaft being rotatable in the second bearing assembly with respect to the second end cap.

4. The turbine assembly of claim 3 for use with the fluid following from the first end portion to the second end portion, wherein the first bearing assembly is a radial bearing assembly configured to prevent the shaft from moving radially within the pipe section, and
the second bearing assembly is a thrust bearing assembly configured to prevent the shaft from moving in the flow direction within the pipe section.

5. The turbine assembly of claim 1, wherein the shaft has an end portion with a keyseat formed therein,
the keyseat is configured to receive a key of a rotatable component of the generator, and
the rotatable component rotates with the shaft when the key is received by the keyseat.

6. The turbine assembly of claim 1, wherein the pressure of the fluid is reduced to below 80 pounds per square inch.

7. The turbine assembly of claim 1, wherein the one or more blades rotate the shaft at less than 400 revolutions per minute.

8. The turbine assembly of claim 1, wherein the shaft and the one or more blades are components of a screw turbine, a vertical axis turbine, or a Kaplan turbine.

9. The turbine assembly of claim 1, wherein the one or more blades are a single helically shaped blade wrapped around the portion of the shaft.

10. A system comprising:
a pipe section conducting a fluid flowing in a flow direction;
a turbine assembly comprising at least one blade connected to a shaft, the at least one blade being positioned inside the pipe section, the at least one blade rotating the shaft when the fluid pushes on the at least one blade; and
a generator connected to the shaft, rotation of the shaft causing the generator to generate electricity.

11. The system of claim 10, further comprising:
a first end cap configured to terminate a first end portion of the pipe section, the first end cap comprising a first through-hole;
a second end cap configured to terminate a second end portion of the pipe section, the second end cap comprising a second through-hole;
a first bearing assembly connected to the first end cap at or near the first through-hole, a first end of the shaft extending through the first through-hole and the first bearing assembly, the first end of the shaft being connected to the generator, the shaft being rotatable in the first bearing assembly with respect to the first end cap; and
a second bearing assembly connected to the second end cap at or near the second through-hole, a second end of the shaft extending through the second through-hole and the second bearing assembly, the shaft being rotatable in the second bearing assembly with respect to the second end cap.

12. The system of claim 11, wherein the first bearing assembly is a radial bearing assembly configured to prevent the shaft from moving radially within the pipe section, and
the second bearing assembly is a thrust bearing assembly configured to prevent the shaft from moving in the flow direction within the pipe section.

13. The system of claim 10, wherein the shaft has an end portion with a keyseat formed therein,
the keyseat is configured to receive a key of a rotatable component of the generator, and
the rotatable component rotates with the shaft when the key is received by the keyseat.

14. The system of claim 10, wherein the turbine assembly comprises a screw turbine, a vertical axis turbine, or a Kaplan turbine.

15. The system of claim 10, wherein the at least one blade is a single helically shaped blade wrapped around a portion of the shaft, and.
the portion of the shaft extends along the flow direction.

16. The system of claim 10, wherein the pipe section has a first end portion opposite a second end portion,
the first end portion receives the fluid from a higher elevation and the second end portion conveys the fluid to a lower elevation thereby inducing the fluid to flow in the flow direction and creating a pressure in the fluid, and
the pressure of the fluid is reduced by the turbine assembly when the fluid pushes on the at least one blade.

17. The system of claim 10, wherein the fluid is potable water conducted by a water system,
the pipe section conducts the potable water from a higher elevation portion of the water system to a lower elevation portion of the water system, and
a pressure of the potable water is reduced by the turbine assembly when the potable water pushes on the at least one blade.

18. A method comprising:
installing at least a portion of a turbine assembly in a pipe section, the portion of the turbine assembly comprising at least one blade connected to at least a portion of a shaft;
connecting the shaft of the turbine assembly to a generator; and
allowing a fluid to flow through the pipe section in a flow direction, the shaft being rotated by the fluid as the fluid flows through the pipe section and pushes on the at least one blade, the shaft driving the generator and causing the generator to generate electricity as the shaft rotates.

19. The method of claim 18, wherein the portion of the shaft is substantially parallel with the flow direction.

20. The method of claim 18, wherein the turbine assembly comprises a screw turbine, a vertical axis turbine, or a Kaplan turbine.

21. The method of claim 18, further comprising:
supplying the electricity to an electric power consuming system.

22. The method of claim 18, wherein the fluid is potable water conducted by a water system,
the pipe section conducts the potable water from a higher elevation portion of the water system to a lower elevation portion of the water system, and
a pressure of the potable water is reduced by the turbine assembly when the potable water pushes on the at least one blade.
